(19) United States
(12) Patent Application Publication
(10) Pub. No.: US 2020/0377622 A1
(43) Pub. Date: Dec. 3, 2020

(54) METHANOL-MEDIATED METHOD FOR SEPARATING ALKALINE SOLUTION OF HEMICELLULOSE AND ETHANOL-MEDIATED METHOD FOR SEPARATING ALKALINE SOLUTION OF HEMICELLULOSE

(71) Applicant: Nanjing Forestry University, Nanjing (CN)

(72) Inventors: Yong Xu, Nanjing (CN); Jing Luo, Nanjing (CN); Shiyuan Yu, Nanjing (CN)

(73) Assignees: Nanjing Forestry University, Nanjing (CN); Nanjing Forestry University, Nanjing (CN)

(21) Appl. No.: 16/333,944

(22) PCT Filed: Jun. 12, 2018
(86) PCT No.: PCT/CN2018/090851

§ 371 Date: Mar. 15, 2019

(30) Foreign Application Priority Data
Dec. 20, 2017 (CN) 201711414868.6
Mar. 12, 2018 (CN) 201810200978.0

(51) Int. Cl. C08B 37/00; B01D 21/01; B01D 21/26; B01D 3/08; B01D 3/10; B01F 1/00

(52) U.S. Cl. CPC C08B 37/0057; B01D 21/01; B01F 1/0005; B01D 3/085; B01D 3/10; B01D 21/262

(57) ABSTRACT

The present invention discloses a methanol-mediated method for separating an alkaline solution of hemicellulose, and an ethanol-mediated method for separating an alkaline solution of hemicellulose, where methanol/ethanol is added into the alkaline solution in which hemicellulose is dissolved, and stirred thoroughly until the mixture is homogeneous, to destroy the hydrated layer effect formed between the hemicellulose and the alkaline solution through the methanol/ethanol-mediated hydrophobic effect, such that hemicellulose is precipitated from the solution system, and then the mixture is subjected to separation by sedimentation, centrifugation or filtration to obtain a precipitate of hemicellulose and an alkaline solution of methanol/ethanol; and by using the prompting effect of an alkaline condition on evaporation and gasification separation of methanol/ethanol from water, a reduced-pressure distillation (rectification) or gasification membrane is used to separate methanol/ethanol from the alkaline solution, and the obtained alkaline solution and methanol/ethanol are reused for dissolution and separation of hemicellulose. By the complete reuse of the alkaline solution and methanol/ethanol in the method of the present invention, it achieves efficient, clean and economical production of alkaline dissolution and separation of hemicellulose, and the separation and recovery efficiency of the hemicellulose dissolved in the alkaline exceeds 99%.

### CROSS-REFERENCE

This application claims priority to Chinese patent application No. CN201711414868.6 filed to the National Intellectual Property Administration on Dec. 20, 2017 and entitled “METHOD FOR IN SITU SEPARATING AND RECOVERING HEMICELLULOSE FROM STRONG ALKALINE SOLUTION”, and Chinese patent application No. CN201810200978.0 filed to the National Intellectual Property Administration on Mar. 12, 2018 and entitled “METHANOL-MEDIATED METHOD FOR HYDROPHOBIC EFFICIENT SEPARATION AND REUSE OF ALKALINE SOLUTION AND HEMICELLULOSE DISSOLVED THEREIN”, which are herein incorporated by reference in their entireties.

### TECHNICAL FIELD

The present invention relates to the technical field of hemicellulose separation, and in particular to a methanol-mediated method for separating an alkaline solution of hemicellulose, and an ethanol-mediated method for separating an alkaline solution of hemicellulose.

### BACKGROUND

Hemicellulose mainly refers to a linear or branched body-type super-polysaccharide substance with xylan or glucomannan as the main chain, which is the second largest class of super-polysaccharide component second only to cellulose in a lignocellulosic raw material. In a production process of processing a lignocellulosic raw material and its semi-finished product into paper pulp, viscose fiber, hemicellulose, xylooligosaccharide, and the like product in a chemical, biological and the like manner, it is necessary to treat the raw material with a strong alkaline solution having a mass concentration of 5%-25% such as sodium hydroxide, potassium hydroxide, liquid nitrogen and the like, to dissolve and separate xylan and mannan hemicellulose components from the raw material, thereby generating a large amount of a high-viscosity and strongly-basic solution rich in hemicellulose. It is necessary to effectively separate the xylan contained in the solution, thereby reusing the alkaline solution, reducing water consumption and environmental pollution, and reducing the production cost. The existing separation of the alkaline solution of hemicellulose substantially adopts an ultrafiltration method, but it is often difficult for a conventional ultrafiltration device to directly treat the alkaline solution of hemicellulose having such alkali concentration and high viscosity. Even after the solution is diluted with water, the ultrafiltration operation will generate a large amount of a low-concentration alkaline permeate containing some permeated hemicellulose components, and causes a barrier to reuse of the alkaline solution, which ultimately results in high water consumption, membrane loss, and operating cost of the production.

### SUMMARY

Directed to the problem that it is difficult to efficiently separate and reuse an alkaline solution of hemicellulose, the present invention provides a methanol-mediated method for separating an alkaline solution of hemicellulose, and an ethanol-mediated method for separating an alkaline solution of hemicellulose.

Fully utilizing the physicochemical properties of methanol in dissolving and precipitating hemicellulose dissolved in an alkaline solution, the present invention forms a methanol-mediated hydrophobic effect to destroy the affinity effect between hemicellulose and the alkaline solution, and thus to promote efficient separation and in situ precipitation of hemicellulose from the alkaline solution of methanol, thereby achieving efficient separation and preparation of hemicellulose, where the recovery rate of hemicellulose exceeds 99%, and the residual rate of hemicellulose in the alkaline solution of methanol is less than 0.2%; and by using the physicochemical properties of methanol that methanol is evaporated and vaporized in an alkaline aqueous solution, a distillation (rectification) or gasification membrane is used to efficiently separate the methanol alkaline solution system to respectively obtain methanol and the alkaline solution, such that the recovery of methanol can be completed, with the residual rate of methanol in the alkaline solution being less than 0.02%.

By using ethanol, the present invention effectively destroys a hydrogen bond and hydrated layer of a hemicellulose molecule in a strong alkaline solution, and changes the conformation of the super-polysaccharide macromolecule and thus significantly reduces the solubility of the super-polysaccharide macromolecule, thereby promoting the precipitation of hemicellulose from the strong alkaline solution to achieve efficient in situ separation of hemicellulose; and at the same time, by using the improving effect of a high-concentration alkali on the extractive distillation performance of an ethanol/water system, a distillation, rectification or gasification membrane technology is used to efficiently separate ethanol and the alkaline solution and thus improve the reuse quality performances of them, finally realizing the simple, rapid and efficient separation and recovery of the strong alkaline solution of hemicellulose, and significantly improving the economic and environmental benefits of the production system in which hemicellulose is prepared through dissolution and separation by a strong alkali method.

To achieve the above technical problem, the present invention adopts the following technical solutions:

A methanol-mediated method for hydrophobic efficient separation and reuse of an alkaline solution and hemicellulose dissolved therein includes the steps of:
1) adding methanol into the alkaline solution in which hemicellulose is dissolved, stirring thoroughly until the mixture is homogeneous, and allowing to stand for settling;
2) subjecting the system of step 1) to solid-liquid separation to obtain a supernatant being an alkaline solution of methanol and a precipitate being hemicellulose;
3) separating the alkaline solution of methanol through a distillation or rectification or gasification membrane to obtain methanol and the alkaline solution respectively; and
4) reusing the separated alkaline solution and methanol for dissolution, separation and preparation of hemicellulose.

Preferably, the alkaline solution is any one of a sodium hydroxide solution, a potassium hydroxide solution, a calcium hydroxide solution, a sodium carbonate solution, and a potassium carbonate solution, or a mixture thereof.

Preferably, the hemicellulose is derived from any one of linear or body types using xylan or glucomannan as the main chain, or a mixture thereof.

Preferably, in step 1), the volume ratio of methanol to the alkaline solution is 1-4:1.

Preferably, in step 2), the solid-liquid separation method is decanting, siphoning, overflowing, filtrating or centrifuging, and a combination thereof.

Preferably, in step 1), it is allowed to stand for settling over 5-30 minutes.

Preferably, in step 2), the recovery yield of hemicellulose exceeds 99%, and the residual rate of hemicellulose in the alkaline solution of methanol is below 0.5%.

Preferably, in step 3), the recovery rate of methanol exceeds 98%, and the residue methanol concentration of the alkaline solution is below 0.05%.

A method for in situ separating and recovering hemicellulose from a strong alkaline solution includes the steps of:
(1) under a condition of sufficient stirring, adding 20%-80% ethanol into the strong alkaline solution containing hemicellulose according to the initial volume ratio of the solution at a constant speed, mixing well and then allowing to stand at room temperature for 15-150 min, such that hemicellulose precipitates in situ from the system of the strong alkaline solution;
(2) subjecting the solution system prepared in step (1) to solid-liquid separation by a decanting, siphoning, overflowing, filtrating or centrifuging method, to obtain a supernatant being the alkaline solution of ethanol and a precipitate being hemicellulose respectively, with the mass recovery rate of hemicellulose exceeding 90%; and
(3) adding an appropriate amount of ethanol solution based on the volume concentration of ethanol in step (1) to wash and separate the precipitate until pH 6.00-7.00, so as to prepare high-purity hemicellulose; combining the ethanol cleaning solution with the alkaline solution of ethanol of step (2), and using a distillation, rectification or gasification membrane to separate ethanol and the strong alkaline solution for reuse; with the mass recovery rate of ethanol exceeding 92%, and the residual ethanol concentration in the strong alkaline solution being below 0.05 g/L.

Preferably, the hemicellulose in the strongly alkaline solution refers to a linear or body-type single substance using xylan or glucomannan as the main chain, or a mixture thereof

Preferably, the addition amount of ethanol is calculated according to an initial volume ratio of ethanol to the strong alkaline solution, and the volume ratio of ethanol is 20%-80%.

Preferably, the strong alkaline solution refers to an alkaline solution formulated from any one of sodium hydroxide, potassium hydroxide and liquid ammonia or any combination thereof, with the solution pH≥10.0.

Preferably, the separation method of the mixed system of ethanol in the alkaline solution refers to any one of a decanting, siphoning, overflowing, filtrating or centrifuging method, or any combination thereof.

Preferably, the method for gasification separation and reuse of the alkaline solution of ethanol refers to any one of distillation, rectification, gasification membrane separation methods or any combination thereof; and the mass recovery rate of ethanol exceeds 92%, and the residual ethanol concentration in the strong alkaline solution is below 0.05 g/L.

Compared with the prior art, adopting the method of the present invention can achieve efficient separation and reuse of hemicellulose and the alkaline solution, with no water consumption and significantly-reduced power consumption and production cost; methanol has a significantly reduced boiling point and does not form a azeotrope with water, and thus the effect of separating it from the alkaline solution through evaporation (rectification) and gasification is better and has a lower cost, and thus has good practicability.

### DETAILED DESCRIPTION

The present invention is further described below with reference to embodiments.

### Embodiment 1

Into a reaction tank added was 300 mL of a strong alkaline solution of hemicellulose (at pH 11.0, with a hemicellulose mass concentration of 3.0% and a sodium hydroxide mass concentration of 17%), added with 750 mL methanol at a constant rate in a fed-batch manner until the mixture was mixed uniformly, and allowed to stand under a condition of room temperature over 15 min until complete precipitation. A precipitate was obtained by centrifuging the remaining solution with a tubular bowl centrifuge under a centrifugal force of 9000 g for 5 min. The precipitate was washed with 200 mL of 70% methanol solution twice to obtain hemicellulose, with the recovery rate of hemicellulose reached 99.2%; the centrifugation supernatant was the alkaline solution of methanol, with the recovery rate of alkali reached 98%. A rotary evaporator was used to separate the alkaline solution of methanol through rectification by controlling the vacuum degree to 100 mbar and the feed-solution temperature at the kettle bottom to 55-64° C. and using water of 2° C. as a condensing medium, and the obtained methanol solution and strong alkaline solution could be reused when the mass recovery rate of methanol exceeded 98.6% and the residual mass concentration of methanol in the alkaline solution was below 0.02%.

### Embodiment 2

Into a cone-bottom stainless steel reaction tank added was 10 L of a strong alkaline solution of hemicellulose (at pH 13.8, with a hemicellulose mass concentration of 4.0% and a sodium hydroxide mass concentration of 20%), stirred by activating a mechanical stirring device, added with 30 L methanol at a constant rate in a fed-batch manner until the mixture was mixed uniformly, and allowed to stand under a condition of room temperature over 30 min until complete precipitation. A precipitate was obtained by centrifuging the remaining solution with a tubular bowl centrifuge under a centrifugal force of 9000 g for 10 min. The precipitate was washed with 6 L formic acid solution having a concentration of 70% twice to obtain hemicellulose, with the recovery rate of hemicellulose reached 99.1%; the centrifugation supernatant was the alkaline solution of methanol, with the recovery rate of alkali reached 98%. A packed distillation column was used to separate the alkaline solution of methanol through rectification by controlling the vacuum degree to 100 mbar and the feed-solution temperature at the kettle bottom to 65-70° C. and using water of 2° C. as a condensing medium, and the obtained methanol solution and strong alkaline solution could be reused when the mass recovery rate of methanol exceeded 98.4% and the residual mass concentration of methanol in the alkaline solution was below 0.05%.

### COMPARATIVE EXAMPLE 1

Into a reaction tank added was 300 mL of a strong alkaline solution of hemicellulose (at pH 11.0, with a hemicellulose mass concentration of 3.0% and a sodium hydroxide mass concentration of 17%), stirred by activating a mechanical stirring device, added with 300 mL ethanol at a constant rate in a fed-batch manner until the mixture was mixed uniformly, and allowed to stand under a condition of room temperature over 30 min until complete precipitation. The supernatant A was drawn by a pipette until 400 mL, and the remaining solution was centrifuged with a tubular bowl centrifuge under a centrifugal force of 5,844 g for 60 min to obtain a precipitate. The precipitate was twice washed with 500 mL of an ethanol solution (with the initial volume ratio of ethanol to water of 80%:20%) and then centrifuged to obtain hemicellulose, with the recovery rate of hemicellulose reached 91.4%; the centrifugation supernatants were combined to obtain the alkaline solution of ethanol, with the recovery rate of alkali reached 95%. A rotary evaporator was used to separate the alkaline solution of ethanol through rectification by controlling the vacuum degree to 100 mbar and the feed-solution temperature at the kettle bottom to 60-62° C. and using water of 18° C. as a condensing medium, and the obtained ethanol solution and strong alkaline solution could be reused when the mass recovery rate of ethanol exceeded 96.2% and the residual mass concentration of ethanol in the alkaline solution was below 0.03%.

### COMPARATIVE EXAMPLE 2

Into a cone-bottom stainless steel reaction tank added was 10 L of a strong alkaline solution of hemicellulose (at pH 13.8, with a hemicellulose mass concentration of 4.0% and a sodium hydroxide mass concentration of 20%), stirred by activating a mechanical stirring device, added with 8 L ethanol at a constant rate in a fed-batch manner until the mixture was mixed uniformly, and allowed to stand under a condition of room temperature over 20 min until complete precipitation. The supernatant A was drawn by a siphon tube until 12-12.5 L, and the remaining solution was centrifuged with a tubular bowl centrifuge under a centrifugal force of 5,844 g for 10 min to obtain a precipitate. The precipitate was twice washed with 2 L of an ethanol solution (with the initial volume ratio of ethanol to water of 80%:20%) and then centrifuged to obtain hemicellulose, with the recovery rate of hemicellulose reached 92.6%; the centrifugation supernatants were combined to obtain the alkaline solution of ethanol, with the recovery rate of alkali reached 98%. A packed distillation column was used to separate the alkaline solution of ethanol through rectification by controlling the vacuum degree to 100 mbar and the feed-solution temperature at the kettle bottom to 68-70° C. and using water of 18° C. as a condensing medium, and the obtained ethanol solution and strong alkaline solution could be reused when the mass recovery rate of ethanol exceeded 95% and the residual mass concentration of ethanol in the alkaline solution was below 0.04%.

### Embodiment 3

Into a reaction tank added was 300 mL of a strong alkaline solution of hemicellulose (at pH 11.0, with a hemicellulose mass concentration of 3.0% and a sodium hydroxide mass concentration of 17%), stirred by activating a mechanical stirring device, added with 300 mL ethanol at a constant rate in a fed-batch manner until the mixture was mixed uniformly, and allowed to stand under a condition of room temperature over 30 min until complete precipitation. The supernatant A was drawn by a pipette until 400 mL, and the remaining solution was centrifuged with a tubular bowl centrifuge under a centrifugal force of 5,844 g for 60 min to obtain a precipitate. The precipitate was twice washed with 500 mL of an ethanol solution (with the initial volume ratio of ethanol to water of 80%:20%) and then centrifuged to obtain hemicellulose, with the recovery rate of hemicellulose reached 91.4%; the centrifugation supernatants were combined to obtain the alkaline solution of ethanol, with the recovery rate of alkali reached 95%. A rotary evaporator was used to separate the alkaline solution of ethanol through rectification by controlling the vacuum degree to 100 mbar and the feed-solution temperature at the kettle bottom to 60-62° C. and using water of 18° C. as a condensing medium, and the obtained ethanol solution and strong alkaline solution could be reused when the mass recovery rate of ethanol exceeded 96.2% and the residual mass concentration of ethanol in the alkaline solution was below 0.03%.

### Embodiment 4

Into a cone-bottom stainless steel reaction tank added was 10 L of a strong alkaline solution of hemicellulose (at pH 13.8, with a hemicellulose mass concentration of 4.0% and a sodium hydroxide mass concentration of 20%), stirred by activating a mechanical stirring device, added with 8 L ethanol at a constant rate in a fed-batch manner until the mixture was mixed uniformly, and allowed to stand under a condition of room temperature over 20 min until complete precipitation. The supernatant A was drawn by a siphon tube until 12-12.5 L, and the remaining solution was centrifuged with a tubular bowl centrifuge under a centrifugal force of 5,844 g for 10 min to obtain a precipitate. The precipitate was twice washed with 2 L of an ethanol solution (with the initial volume ratio of ethanol to water of 80%:20%) and then centrifuged to obtain hemicellulose, with the recovery rate of hemicellulose reached 92.6%; the centrifugation supernatants were combined to obtain the alkaline solution of ethanol, with the recovery rate of alkali reached 98%. A packed distillation column was used to separate the alkaline solution of ethanol through rectification by controlling the vacuum degree to 100 mbar and the feed-solution temperature at the kettle bottom to 68-70° C. and using water of 18° C. as a condensing medium, and the obtained ethanol solution and strong alkaline solution could be reused when the mass recovery rate of ethanol exceeded 95% and the residual mass concentration of ethanol in the alkaline solution was below 0.04%.

The above description of the embodiment is only for helping to understand the method of the present invention and its core idea. It should be noted that, several improvements and modifications may be made by persons of ordinary skill in the art without departing from the principle of the present invention, and these improvements and modifications should also be considered within the protection scope of the present invention. Various modifications to these embodiments are readily apparent to persons skilled in the art, and the generic principles defined herein may be practiced in other embodiments without departing from the spirit or scope of the invention. Thus, the present invention is not limited to the embodiments shown herein but falls within the widest scope consistent with the principles and novel features disclosed herein.

What is claimed is:

1. A methanol-mediated method for hydrophobic efficient separation and reuse of an alkaline solution and hemicellulose dissolved therein, comprising the steps of:
1) adding methanol into the alkaline solution in which hemicellulose is dissolved, stirring thoroughly until the mixture is homogeneous, and allowing to stand for settling;
2) subjecting the system of step 1) to solid-liquid separation to obtain a supernatant being an alkaline solution of methanol and a precipitate being hemicellulose;
3) separating the alkaline solution of methanol through a distillation or rectification or gasification membrane to obtain methanol and the alkaline solution respectively; and
4) reusing the separated alkaline solution and methanol for dissolution, separation and preparation of hemicellulose.

2. The methanol-mediated method for hydrophobic efficient separation and reuse of an alkaline solution and hemicellulose dissolved therein according to claim 1, wherein the alkaline solution is any one of a sodium hydroxide solution, a potassium hydroxide solution, a calcium hydroxide solution, a sodium carbonate solution, and a potassium carbonate solution, or a mixture thereof.

3. The methanol-mediated method for hydrophobic efficient separation and reuse of an alkaline solution and hemicellulose dissolved therein according to claim 1, wherein the hemicellulose is derived from any one of linear or body types using xylan or glucomannan as the main chain, or a mixture thereof.

4. The methanol-mediated method for hydrophobic efficient separation and reuse of an alkaline solution and hemicellulose dissolved therein according to claim 1, wherein in step 1), the volume ratio of methanol to the alkaline solution is 1-4:1.

5. The methanol-mediated method for hydrophobic efficient separation and reuse of an alkaline solution and hemicellulose dissolved therein according to claim 1, wherein in step 2), the solid-liquid separation method is decanting, siphoning, overflowing, filtrating or centrifuging, and a combination thereof.

6. The methanol-mediated method for hydrophobic efficient separation and reuse of an alkaline solution and hemicellulose dissolved therein according to claim 1, wherein in step 1), it is allowed to stand for settling over 5-30 minutes.

7. The methanol-mediated method for hydrophobic efficient separation and reuse of an alkaline solution and hemicellulose dissolved therein according to claim 1, wherein in step 2), the recovery yield of hemicellulose exceeds 99%, and the residual rate of hemicellulose in the alkaline solution of methanol is below 0.5%.

8. The methanol-mediated method for hydrophobic efficient separation and reuse of an alkaline solution and hemicellulose dissolved therein according to claim 1, wherein in step 3), the recovery rate of methanol exceeds 98%, and the residue methanol concentration of the alkaline solution is below 0.05%.

9. A method for in situ separating and recovering hemicellulose from a strong alkaline solution, comprising the steps of:
(1) under a condition of sufficient stirring, adding 20%-80% ethanol into the strong alkaline solution containing hemicellulose according to the initial volume ratio of the solution at a constant speed, mixing well and then allowing to stand at room temperature for 15-150 min, such that hemicellulose precipitates in situ from the system of the strong alkaline solution;
(2) subjecting the solution system prepared in step (1) to solid-liquid separation by a decanting, siphoning, overflowing, filtrating or centrifuging method, to obtain a supernatant being the alkaline solution of ethanol and a precipitate being hemicellulose respectively, with the mass recovery rate of hemicellulose exceeding 90%; and
(3) adding an appropriate amount of ethanol solution based on the volume concentration of ethanol in step (1) to wash and separate the precipitate until pH 6.00-7.00, so as to prepare high-purity hemicellulose; combining the ethanol cleaning solution with the alkaline solution of ethanol of step (2), and using a distillation, rectification or gasification membrane to separate ethanol and the strong alkaline solution for reuse; with the mass recovery rate of ethanol exceeding 92%, and the residual ethanol concentration in the strong alkaline solution being below 0.05 g/L.

10. The method for in situ separating and recovering hemicellulose from a strong alkaline solution according to claim 9, wherein the hemicellulose in the strongly alkaline solution refers to a linear or body-type single substance using xylan or glucomannan as the main chain, or a mixture thereof.

11. The method for in situ separating and recovering hemicellulose from a strong alkaline solution according to claim 9, wherein the addition amount of ethanol is calculated according to an initial volume ratio of ethanol to the strong alkaline solution, and the volume ratio of ethanol is 20%-80%.

12. The method for in situ separating and recovering hemicellulose from a strong alkaline solution according to claim 9, wherein the strong alkaline solution refers to an alkaline solution formulated from any one of sodium hydroxide, potassium hydroxide and liquid ammonia or any combination thereof, with the solution pH≥10.0.

13. The method for in situ separating and recovering hemicellulose from a strong alkaline solution according to claim 9, wherein the separation method of the mixed system of ethanol in the alkaline solution refers to any one of a decanting, siphoning, overflowing, filtrating or centrifuging method, or any combination thereof.

14. The method for in situ separating and recovering hemicellulose from a strong alkaline solution according to claim 9, wherein the method for gasification separation and reuse of the alkaline solution of ethanol refers to any one of distillation, rectification, gasification membrane separation methods or any combination thereof and the mass recovery rate of ethanol exceeds 92%, and the residual ethanol concentration in the strong alkaline solution is below 0.05 g/L.
